(19) United States
(12) Patent Application Publication
(10) Pub. No.: US 2018/0011202 A1
(43) Pub. Date: Jan. 11, 2018

(54) METHOD FOR CALCULATING ATTITUDE ANGLE AND APPARATUS THEREFOR

(71) Applicant: Getac Technology Corporation, Hsinchu County (TW)

(72) Inventor: Hung-Tu CHEN, Taipei (TW)

(21) Appl. No.: 15/202,739

(22) Filed: Jul. 6, 2016

(51) Int. Cl. G01S 19/53

(52) U.S. Cl. CPC G01S 19/53

(57) ABSTRACT

A method for calculating an attitude angle and an apparatus therefor are provided. The method includes: detecting a satellite signal by using a first antenna array to obtain a plurality of first input signals, detecting the satellite signal by using a second antenna array to obtain a plurality of second input signals, performing a phase operation according to the plurality of first input signals to generate a plurality of first output signals, performing the phase operation according to the plurality of second input signals to generate a plurality of second output signals, obtaining a relative attitude angle according to the plurality of first output signals and the plurality of second output signals, obtaining an absolute attitude angle from the satellite signal, and generating an actual attitude angle of a vehicle according to the absolute attitude angle and the relative attitude angle.

### BACKGROUND OF THE INVENTION

### Field of the Invention

The present invention relates to an antenna module and a method for positioning by using same, and in particular, to a method for calculating an attitude angle and an apparatus therefor.

### Description of the Prior Art

The Global Positioning System (GPS) is a positioning technology combining satellites and wireless communications and can provide accurate positioning information, speed information, and time information. The GPS may be combined with an electronic map to display positioning information obtained by means of positioning on the electronic map, so as to provide the positioning information for a user to learn a current position thereof. Further, as the navigation system technology becomes mature, the positioning technology, in combination with a navigation system, is applied to mobile phones, computers, various means of transportation, and the like, an application range thereof becomes increasingly wider, and a lot of convenience is provided for life of human beings.

However, most positioning technologies merely provide position information of an user in a two-dimensional space, and an user usually cannot clearly know a current position and a direction to advance according to two-dimensional positioning information. When a driver is in an unfamiliar environment, the two-dimensional positioning information cannot provide effective guidance.

### SUMMARY OF THE INVENTION

In view of this, the present invention provides a method for calculating an attitude angle in a three-dimensional space and an apparatus therefor.

In some embodiments, a method for calculating an attitude angle, applicable to a vehicle, is provided, where the method for calculating an attitude angle includes: detecting a satellite signal by using a first antenna array to obtain a plurality of first input signals, detecting the satellite signal by using a second antenna array to obtain a plurality of second input signals, performing a phase operation according to the plurality of first input signals to generate a plurality of first output signals, performing the phase operation according to the plurality of second input signals to generate a plurality of second output signals, obtaining a relative attitude angle according to the plurality of first output signals and the plurality of second output signals, obtaining an absolute attitude angle from the satellite signal, and generating an actual attitude angle of the vehicle according to the absolute attitude angle and the relative attitude angle.

In some embodiments, an apparatus for calculating an attitude angle, applicable to vehicle, is provided, where the apparatus for calculating an attitude angle includes a first antenna array, a second antenna array, a first signal processing unit, a second signal processing unit, and a processing unit. The first antenna array detects a satellite signal to obtain a plurality of first input signals. The second antenna array detects the satellite signal to obtain a plurality of second input signals. The first signal processing unit performs a phase operation according to the plurality of first input signals to generate a plurality of first output signals. The second signal processing unit performs the phase operation according to the plurality of second input signals to generate a plurality of second output signals. The processing unit obtains a relative attitude angle according to the plurality of first output signal and the plurality of second output signal and generates an actual attitude angle of the vehicle according to an absolute attitude angle and the relative attitude angle, where the absolute attitude angle is from the satellite signal.

In conclusion, in an embodiment of an apparatus for calculating an attitude angle according to the present invention, an actual attitude angle of an antenna in a three-dimensional space is obtained by using an absolute attitude angle of a GPS satellite relative to the ground and relative attitude angles of the GPS satellite relative to two antenna arrays. When the antenna is applied to a vehicle, a control person or a computer of the vehicle may obtain positioning information of the vehicle in the three-dimensional space according to the attitude angle, so as to further provide more accurate positioning information.

### BRIEF DESCRIPTION OF THE DRAWINGS

FIG. 1 illustrates a schematic block diagram of an embodiment of an apparatus for calculating an attitude angle according to the present invention;

FIG. 2 illustrates a top view of an embodiment of disposing a first antenna, a second antenna, a third antenna, a fourth antenna, and a fifth antenna in FIG. 1 together on a substrate;

FIG. 3 illustrates a side view of an embodiment of a satellite signal being incident on the first antenna, second antenna, third antenna, fourth antenna, and fifth antenna in FIG. 2;

FIG. 4 shows a schematic diagram of an embodiment of representing an absolute attitude angle of a GPS satellite;

FIG. 5 illustrates a schematic block diagram of an embodiment of a first signal processing unit in FIG. 1;

FIG. 6 illustrates a schematic block diagram of an embodiment of a second signal processing unit in FIG. 1;

FIG. 7 shows a schematic diagram of an embodiment of correspondences between signal strength of a first combined signal, signal strength of a second combined signal, signal strength of a third combined signal, and signal strength of a fourth combined signal and a first incident angle; and

FIG. 8 illustrates a flowchart of an embodiment of a method for calculating an attitude angle according to the present invention.

### DETAILED DESCRIPTION OF THE EMBODIMENTS

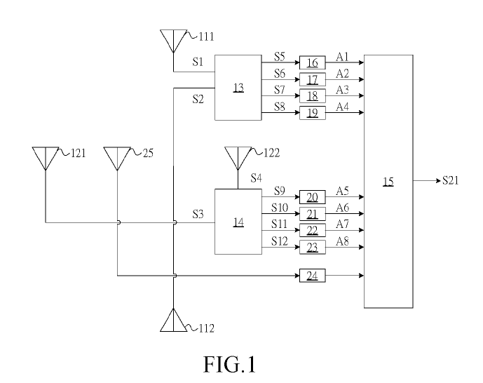

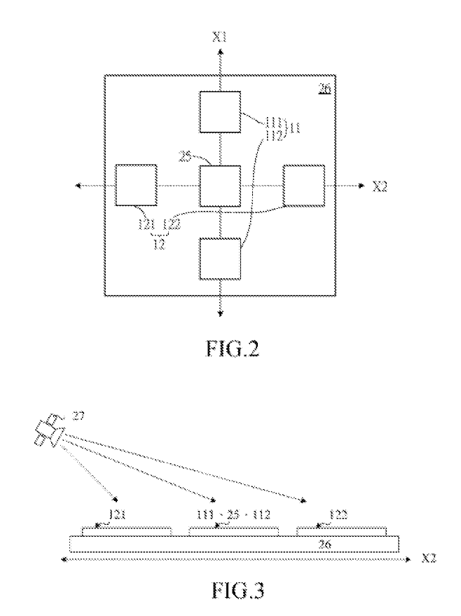

FIG. 1 illustrates a schematic block diagram of an embodiment of an apparatus for calculating an attitude angle according to the present invention. FIG. 2 illustrates a top view of an embodiment of disposing a first antenna 111, a second antenna 112, a third antenna 121, a fourth antenna 122, and a fifth antenna 25 in FIG. 1 together on a substrate 26. FIG. 3 illustrates a side view of an embodiment of a satellite signal being incident on the first antenna 111, second antenna 112, third antenna 121, fourth antenna 122, and fifth antenna 25 in FIG. 2.

Referring to FIG. 1 to FIG. 3 at the same time, the apparatus for calculating an attitude angle includes a first antenna 111, a second antenna 112, a third antenna 121, a fourth antenna 122, a fifth antenna 25, a first signal processing unit 13, a second signal processing unit 14, and a processing unit 15, as well as nine positioning modules 16 to 24. The first antenna 111 and the second antenna 112 form a first antenna array 11, and the third antenna 121 and the fourth antenna 122 form a second antenna array 12. The first antenna array 11, the first signal processing unit 13, and the four positioning modules 16, 17, 18, and 19 may receive a signal from a GPS satellite 27. Similarly, the second antenna array 12, the second signal processing unit 14, and the four positioning modules 20, 21, 22, and 23 may receive the signal from the GPS satellite 27. As shown in FIG. 2, the first antenna 111, the second antenna 112, the third antenna 121, the fourth antenna 122, and the fifth antenna 25 are disposed on the substrate 26 together; the first antenna 111 and second antenna 112 of the first antenna array 11 are disposed on the substrate 26 along a first axial direction X1 of the substrate 26; and the third antenna 121 and fourth antenna 122 of the second antenna array 12 are disposed on the substrate 26 along a second axial direction X2 of the substrate 26. The fifth antenna 25 is disposed between the first antenna 111 and the second antenna 112 and between the third antenna 121 and the fourth antenna 122. Hence, the first antenna 111, the second antenna 112, the third antenna 121, the fourth antenna 122, and the fifth antenna 25 may communicate with the GPS satellite 27 separately to receive satellite signals sent by the GPS satellite 27 as scheduled.

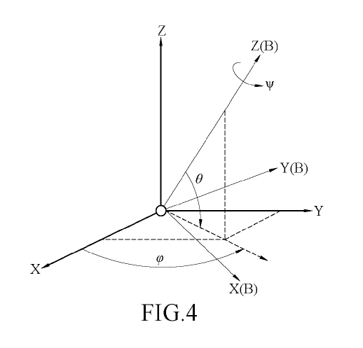

FIG. 4 shows a schematic diagram of an embodiment of representing an absolute attitude angle of a GPS satellite 27. The satellite signal includes ephemeris data and includes an absolute attitude angle of the GPS satellite 27 relative to the ground. The absolute attitude angle includes a pitch angle θ, a yaw angle ψ, and a roll angle φ. A coordinate system represented by coordinate axes X, Y, and Z is a reference coordinate system. A vehicle Z(B) axis may be defined according to a position between the GPS satellite 27 and the vehicle, and a vehicle X(B) axis and a vehicle Y(B) axis may be additionally defined according to the vehicle Z(B) axis. Under the coordinate system, the pitch angle θ is an included angle between the vehicle Z(B) axis and the ground; the yaw angle ψ is an included angle between a projection of the vehicle Z(B) axis on an X-Y plane; and the roll angle φ is an included angle between the Z(B) axis and a vertical plane that passes through the vehicle X(B) axis. For example, if a position of the GPS satellite 27 is on the Z axis, the pitch angle θ is 90°.

In some embodiments, the first antenna 111, the second antenna 112, the third antenna 121, the fourth antenna 122, and the fifth antenna 25 may be made of a conductive material (for example, copper, silver, iron, aluminum, or an alloy thereof) and are disposed on the substrate 26; alternatively, the first antenna 111, the second antenna 112, the third antenna 121, and the fourth antenna 122 may be printed as traces on a Printed circuit board (PCB), and the printed circuit board is disposed on the substrate 26.

The first antenna array 11 detects a satellite signal sent by the GPS satellite 27, so as to obtain a plurality of first input signals that is incident on the first antenna array 11 from the GPS satellite 27. An input end of the first signal processing unit 13 is coupled to the first antenna array 11 to receive the plurality of first input signals such as radio frequency signals S1 and S2. The first signal processing unit 13 performs a phase operation according to the first input signals to generate a plurality of first output signals such as combined signals S5 to S8. The second antenna array 12 detects the satellite signal sent by the same GPS satellite 27, so as to obtain a plurality of second input signals that is incident on the second antenna array 12 from the GPS satellite 27. An input end of the second signal processing unit 14 is coupled to the second antenna array 12 to receive the plurality of second input signals such as radio frequency signals S3 and S4. The second signal processing unit 14 performs the same phase operation according to the second input signals to generate a plurality of second output signals such as combined signals S9 to S12.

A plurality of input ends of the processing unit 15 is coupled to output ends of eight positioning modules 16 to 23, so as to obtain a relative attitude angle according to the plurality of first output signals and the plurality of second output signals. The relative attitude angle represents a relative position between the vehicle and the satellite. For example, the relative attitude angle presents an included angle of the satellite signal incident on the vehicle Z(B) axis. The relative attitude angle includes an included angle of the satellite signal incident on the first antenna array 11 and an included angle of the satellite signal incident on the second antenna array 12 to represent a relative position of the GPS satellite 27 relative to the first antenna array 11 and the second antenna array 12 in a space. The processing unit 15 obtains the included angle of the satellite signal incident on the first antenna array 11 according to the plurality of first output signals, and the processing unit 15 obtains the included angle of the satellite signal incident on the second antenna array 12 according to the plurality of second output signals. Subsequently, the processing unit 15 further combines the two foregoing included angles to obtain a relative attitude angle.

In another aspect, the ninth positioning module 24 is coupled to the fifth antenna 25 to receive a satellite signal from the GPS satellite 27, and the ninth positioning module 24 transmits the satellite signal to the processing unit 15 to enable the processing unit 15 to obtain an absolute attitude angle in the ephemeris data carried by the GPS satellite 27 from the satellite signal. Finally, the processing unit 15 generates an actual attitude angle S21 of the vehicle according to the absolute attitude angle of the GPS satellite 27 and the relative attitude angle to the vehicle. That is, the processing unit 15 generates pitch angles, yaw angles, and roll angles of the first antenna array 11 and second antenna array 12 in a three-dimensional space according to positions of the first antenna array 11 and the second antenna array 12.

For example, assuming that a pitch angle θ of the absolute attitude angle of the GPS satellite 27 is 90°, and a pitch angle θ of the relative attitude angle obtained from the satellite signal incident on the first antenna array 11 and the second antenna array 12 is 30°, a pitch angle θ of the actual attitude angle of the vehicle is 120°. Hence, in actual application, when the apparatus for calculating an attitude angle is mounted on a vehicle such as an automobile or a ship, a control person or a computer of the vehicle may adjust a direction of an antenna on the vehicle timely according to the actual attitude angle, so as to improve communications quality; and when the apparatus for calculating an attitude angle is mounted on a flying vehicle such as an airplane or a drone, a control person or a computer of the flying vehicle may accurately adjust a flying attitude of the flying vehicle timely according to the actual attitude angle of the antenna. Further, the apparatus for calculating an attitude angle may even be configured to build a three-dimensional map.

In some embodiments, the absolute attitude angle of the GPS satellite 27 may come from the first input signal or the second input signal. That is, the apparatus for calculating an attitude angle could omit the fifth antenna 25 and the ninth positioning module 24. The processing unit 15 may be coupled to the first antenna 111, the second antenna 112, the third antenna 121, and the fourth antenna 122 to obtain the absolute attitude angle of the GPS satellite 27 from the first input signal or second input signal.

Further referring to FIG. 2, a detail operation of the apparatus for calculating an attitude angle is described in the following, by along the first axial direction X1. The first antenna 111 detects the GPS satellite 27 to obtain a first radio frequency signal S1, and the second antenna 112 detects the GPS satellite to obtain a second radio frequency signal S2. Two input ends of the first signal processing unit 13 are respectively coupled to the first antenna 111 and the second antenna 112 to receive the first radio frequency signal S1 and the second radio frequency signal S2; after performing a phase operation according to the first radio frequency signal S1 and the second radio frequency signal S2, the first signal processing unit 13 generates first output signals, and the first output signals include a first combined signal S5, a second combined signal S6, a third combined signal S7, and a fourth combined signal S8.

FIG. 5 illustrates a schematic block diagram of an embodiment of a first signal processing unit 13 in FIG. 1. Referring to FIG. 5, the first signal processing unit 13 includes a splitter (hereinafter referred to as a first splitter 131) and three splitters/combiners (hereinafter referred to as a first 90°-phase-shift splitter/combiner 132, a second 90°-phase-shift splitter/combiner 133, and a third 90°-phase-shift splitter/combiner 134). An input end of the first splitter 131 is coupled to the first antenna 111 to receive the first radio frequency signal S1. The first splitter 131 splits the first radio frequency signal S1 to generate a first split signal S15 and a second split signal S16 that have the same phase and the same amplitude value with respect to the first split signal S15. An input end of the first 90°-phase-shift splitter/combiner 132 is coupled to the second antenna 112 to receive the second radio frequency signal S2. The first 90°-phase-shift splitter/combiner 132 splits the second radio frequency signal S2 into a third split signal S17 and a first phase shift signal S13 that have a phase difference of 90° and the same amplitude value with respect to the first radio frequency signal S1, and there is a phase difference of 90° between the first phase shift signal S13 and the second radio frequency signal S2.

Two input ends of the second 90°-phase-shift splitter/combiner 133 are respectively coupled to an output end of the first splitter 131 and an output end of the first 90°-phase-shift splitter/combiner 132 to receive the first split signal S15 and the third split signal S17. The second 90°-phase-shift splitter/combiner 133 combines the first split signal S15 and the third split signal S17 to generate a first combined signal S5 and a second combined signal S6. Hence, the first combined signal S5 and the second combined signal S6 may be respectively represented as (−j)*(S1+S2) and (S1−S2), where j is used to represent a phase difference. In other words, an amplitude of the first combined signal S5 is a sum of amplitude values of the first radio frequency signal S1 and the second radio frequency signal S2, and an amplitude of the second combined signal S6 is a difference between the amplitude values of the first radio frequency signal S1 and the second radio frequency signal S2.

Two input ends of the third 90°-phase-shift splitter/combiner 134 are respectively coupled to another output end of the first splitter 131 and another output end of the first 90°-phase-shift splitter/combiner 132 to receive the second split signal S16 and the first phase shift signal S13. The third 90°-phase-shift splitter/combiner 134 combines the second split signal S16 and the first phase shift signal S13 to generate a third combined signal S7 and a fourth combined signal S8. Hence, the third combined signal S7 and the fourth combined signal S8 may be respectively represented as (−j)*(S1+S13) and (S1−S13). In other words, an amplitude of the third combined signal S7 is a sum of amplitude values of the first radio frequency signal S1 and the first phase shift signal S13, and an amplitude of the fourth combined signal S8 is a difference between the amplitude values of the first radio frequency signal S1 and the first phase shift signal S13.

Referring to FIG. 1 and FIG. 5 at the same time, an input end of the first positioning module 16 is coupled to an output end of the second 90°-phase-shift splitter/combiner 133 to receive the first combined signal S5 generated by the second 90°-phase-shift splitter/combiner 133. The first positioning module 16 detects the signal strength of the first combined signal S5 to generate first signal strength A1. An input end of the second positioning module 17 is coupled to another output end of the second 90°-phase-shift splitter/combiner 133 to receive the second combined signal S6 generated by the second 90°-phase-shift splitter/combiner 133. The second positioning module 17 detects the signal strength of the second combined signal S6 to generate second signal strength A2. An input end of the third positioning module 18 is coupled to an output end of the third 90°-phase-shift splitter/combiner 134 to receive the third combined signal S7 generated by the third 90°-phase-shift splitter/combiner 134. The third positioning module 18 detects the signal strength of the third combined signal S7 to generate third signal strength A3. An input end of the fourth positioning module 19 is coupled to another output end of the third 90°-phase-shift splitter/combiner 134 to receive the fourth combined signal S8 generated by the third 90°-phase-shift splitter/combiner 134. The fourth positioning module 19 detects the signal strength of the fourth combined signal S8 to generate fourth signal strength A4.

Further referring to FIG. 2, a detail running manner of the apparatus for calculating an attitude angle is described in the following, along the second axial direction X2. The second antenna array 12 generates a plurality of second input signals, including a third radio frequency signal S3 and a fourth radio frequency signal S4. The third antenna 121 detects the GPS satellite 27 to obtain the third radio frequency signal S3, and the fourth antenna 122 detects the GPS satellite 27 to obtain a fourth radio frequency signal S4. Two input ends of the second signal processing unit 14 are respectively coupled to the third antenna 121 and the fourth antenna 122 to receive the third radio frequency signal S3 and the fourth radio frequency signal S4; after performing a phase operation according to the third radio frequency signal S3 and the fourth radio frequency signal S4, the second signal processing unit 14 generates four second output signals, and the second output signals include a fifth combined signal S9, a sixth combined signal S10, a seventh combined signal S11, and an eighth combined signal S12.

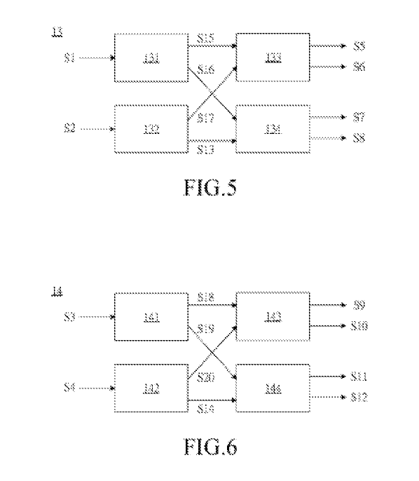

FIG. 6 illustrates a schematic block diagram of an embodiment of a second signal processing unit 14 in FIG. 1. Referring to FIG. 6, the second signal processing unit 14 includes a splitter (hereinafter referred to as a second splitter 141) and three splitters/combiners (hereinafter referred to as a fourth 90°-phase-shift splitter/combiner 142, a fifth 90°-phase-shift splitter/combiner 143, and a sixth 90°-phase-shift splitter/combiner 144). An input end of the second splitter 141 is coupled to the third antenna 121 to receive the third radio frequency signal S3. The second splitter 141 splits the third radio frequency signal S3 to generate a fourth split signal S18 and a fifth split signal S19 that have the same phase and the same amplitude value. An input end of the fourth 90°-phase-shift splitter/combiner 142 is coupled to the fourth antenna 122 to receive the fourth radio frequency signal S4. The fourth 90°-phase-shift splitter/combiner 142 splits the fourth radio frequency signal S4 into a sixth split signal S20 and a second phase shift signal S14 that have a phase difference of 90° and the same amplitude value with respect to the third radio frequency signal S3, and there is a phase difference of 90° between the second phase shift signal S14 and the fourth radio frequency signal S4.

On the basis of this, two input ends of the fifth 90°-phase-shift splitter/combiner 143 are respectively coupled to an output end of the second splitter 141 and an output end of the fourth 90°-phase-shift splitter/combiner 142 to receive the fourth split signal S18 and the sixth split signal S20. The fifth 90°-phase-shift splitter/combiner 143 combines the fourth split signal S18 and the sixth split signal S20 to generate a fifth combined signal S9 and a sixth combined signal S10. An amplitude of the fifth combined signal S9 is a sum of amplitude values of the third radio frequency signal S3 and the fourth radio frequency signal S4, and an amplitude of the sixth combined signal S10 is a difference between the amplitude values of the third radio frequency signal S3 and the fourth radio frequency signal S4. Two input ends of the sixth 90°-phase-shift splitter/combiner 144 are respectively coupled to another output end of the second splitter 141 and another output end of the fourth 90°-phase-shift splitter/combiner 142 to receive the fifth split signal S19 and the second phase shift signal S14. The sixth 90°-phase-shift splitter/combiner 144 combines the fifth split signal S19 and the second phase shift signal S13 to generate a seventh combined signal S11 and an eighth combined signal S12. An amplitude of the seventh combined signal S11 is a sum of amplitude values of the third radio frequency signal S3 and the second phase shift signal S14, and an amplitude of the eighth combined signal S12 is a difference between the amplitude values of the third radio frequency signal S3 and the second phase shift signal S14.

Furthermore, referring to FIG. 1 and FIG. 6 at the same time, an input end of the fifth positioning module 20 is coupled to an output end of the fifth 90°-phase-shift splitter/combiner 143 to receive the fifth combined signal S5 generated by the fifth 90°-phase-shift splitter/combiner 143. The fifth positioning module 20 detects the signal strength of the fifth combined signal S9 to generate fifth signal strength A5. An input end of the sixth positioning module 21 is coupled to an output end of the fifth 90°-phase-shift splitter/combiner 143 to receive the sixth combined signal S10 generated by the fifth 90°-phase-shift splitter/combiner 143. The sixth positioning module 21 detects the signal strength of the sixth combined signal S10 to generate sixth signal strength A6. An input end of the seventh positioning module 22 is coupled to an output end of the sixth 90°-phase-shift splitter/combiner 144 to receive the seventh combined signal S11 generated by the sixth 90°-phase-shift splitter/combiner 144. The seventh positioning module 22 detects the signal strength of the seventh combined signal S11 to generate seventh signal strength A7. An input end of the eighth positioning module 23 is coupled to an output end of the sixth 90°-phase-shift splitter/combiner 144 to receive the eighth combined signal S12 generated by the sixth 90°-phase-shift splitter/combiner 144. The eighth positioning module 23 detects the signal strength of the eighth combined signal S12 to generate eighth signal strength A8.

In some embodiments, the six splitters/combiners 132, 133, 134, 142, 143, and 144 may be implemented as Lange couplers or 90 degree hybrid couplers such as Wilkinson couplers with 90 degree phase jog. Further, the eight positioning modules 16 to 23 may be implemented by using GPS chips to generate eight pieces of signal strength A1 to A8 that are amplitudes or power, and the eight pieces of signal strength A1 to A8 may be represented by carrier-to-noise (C/N) ratios.

On the basis of this, eight input ends of the processing unit 15 are respectively coupled to output ends of the eight positioning modules 16 to 23 to separately receive eight pieces of signal strength A1 to A8. The processing unit 15 generates a first incident angle corresponding to the four pieces of signal strength A1, A2, A3, and A4 together by using a look-up table according to the first signal strength A1, the second signal strength A2, the third signal strength A3, and the fourth signal strength A4 to represent the included angle between the GPS satellite 27 and the first antenna array 11. In addition, the processing unit 15 generates a second incident angle corresponding to the four pieces of signal strength A5, A6, A7, and A8 together by using the look-up table according to the fifth signal strength A5, the sixth signal strength A6, the seventh signal strength A7, and the eighth signal strength A8 to represent the included angle between the GPS satellite 27 and the second antenna array 12.

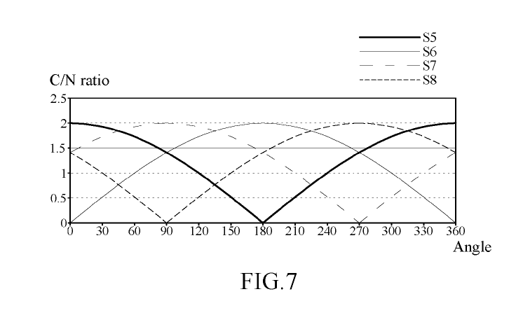

FIG. 7 shows a schematic diagram of an embodiment of correspondences between signal strength of a first combined signal S5, signal strength of a second combined signal S6, signal strength of a third combined signal S7, and signal strength of a fourth combined signal S8 and a first incident angle. A horizontal axis in FIG. 7 represents an angle of the first incident angle, which ranges from 0 to 360°; and a vertical axis in FIG. 7 represents signal strength of the four combined signals S5 to S8, which are presented by C/N ratios and range from 0 to 2.5. Referring to FIG. 7, assuming that a C/N ratio of the first signal strength A1 of the first combined signal S5 is 1.93, a C/N ratio of the second signal strength A2 of the second combined signal S6 is 0.5, a C/N ratio of the third signal strength A3 of the third combined signal S7 is 1.73, and a C/N ratio of the fourth signal strength A4 of the fourth combined signal S8 is 1, an incident angle corresponding to the four pieces of signal strength A1 to A4 is 30°. Hence, the processing unit 15 may search the loop-up table according to a correspondence between the C/N ratio and the angle degree as shown in FIG. 7 to generate the first incident angle. Similarly, the processing unit 15 may also search the loop-up table according to a correspondence between a combination of the four pieces of signal strength A5 to A8 and the second incident to generate the second incident angle. Finally, the processing unit 15 further combines the first incident angle and second incident angle to generate a relative attitude angle. In practice, the two foregoing correspondences may be saved in advance in a register of the processing unit 15 or another component having a storing capability.

In some embodiments, the first antenna array 11 is perpendicular to the first antenna array 12. That is, the second axial direction X2 is perpendicular to the first axial direction X1. The coordinate system of FIG. 4 is used as an example, where if the first axial direction X1 is an X-axis direction, the second axial direction X2 may be a Z-axis direction or a Y-axis direction.

In some embodiments, a number of GPS satellites is preferably four, the apparatus for calculating an attitude angler separately receives satellite signals sent by four GPS satellite, so as to enable the processing unit 15 to generate a more accurate actual attitude angle.

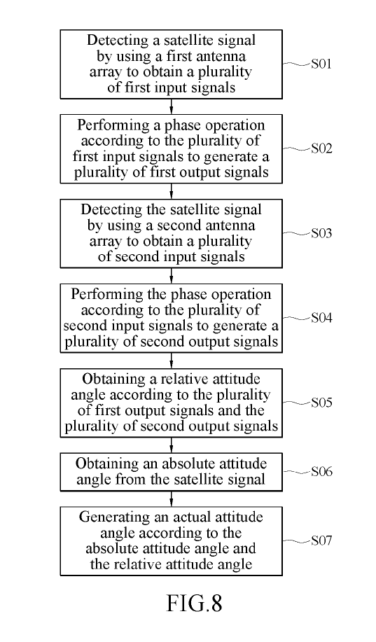

It could be known from the running of the foregoing apparatus for calculating an attitude angle that, the present invention further provides a method for calculating an attitude angle. FIG. 8 is a flowchart of an embodiment of a method for calculating an attitude angle according to the present invention. Referring to FIG. 1, FIG. 2, and FIG. 8 at the same time, the method for calculating an attitude angle includes: detecting a satellite signal by using a first antenna array 11 to obtain a plurality of first input signals (step S01), performing a phase operation according to the plurality of first input signals to generate a plurality of first output signals (step S02), detecting the satellite signal by using a second antenna array 12 to obtain a plurality of second input signals (step S03), performing the phase operation according to the plurality of second input signals to generate a plurality of second output signals (step S04), obtaining a relative attitude angle according to the plurality of first output signals and the plurality of second output signals (step S05), obtaining an absolute attitude angle from the satellite signal (step S06), and generating an actual attitude angle S21 in the three-dimensional space according to the absolute attitude angle and the relative attitude angle (step S07).

In conclusion, in an embodiment of the apparatus for calculating an attitude angle according to the present invention, an actual attitude angle of an antenna in a three-dimensional space is obtained by using an absolute attitude angle of a GPS satellite relative to the ground and relative attitude angles of the GPS satellite relative to two antenna arrays. When the antenna is applied to a vehicle, a control person or a computer of the vehicle may obtain positioning information of the vehicle in the three-dimensional space according to the attitude angle, so as to further provide more accurate positioning information.

What is claimed is:

1. A method for calculating an attitude angle, applicable to a vehicle, wherein the method comprises:
detecting a satellite signal by using a first antenna array to obtain a plurality of first input signals;
detecting the satellite signal by using a second antenna array to obtain a plurality of second input signals;
performing a phase operation according to the plurality of first input signals to generate a plurality of first output signals;
performing the phase operation according to the plurality of second input signals to generate a plurality of second output signals;
obtaining a relative attitude angle according to the plurality of first output signals and the plurality of second output signals;
obtaining an absolute attitude angle from the satellite signal; and
generating an actual attitude angle according to the absolute attitude angle and the relative attitude angle.

2. The method for calculating an attitude angle according to claim 1, wherein the plurality of first input signals comprise a first radio frequency signal and a second radio frequency signal, the plurality of first output signal comprise a first combined signal, a second combined signal, a third combined signal, and a fourth combined signal, and the step of performing the phase operation according to the plurality of first input signals to generate the plurality of first output signals further comprise:
generating a first phase shift signal according to the second radio frequency signal, wherein there is a phase difference of 90° between the first phase shift signal and the second radio frequency signal;
generating the first combined signal and the second combined signal according to signal strength of the first radio frequency signal and signal strength of the second radio frequency signal, wherein signal strength of the first combined signal equals a sum of the signal strength of the first radio frequency signal and the signal strength of the second radio frequency signal, and signal strength of the second combined signal equals a difference between the signal strength of the first radio frequency signal and the signal strength of the second radio frequency signal; and
generating the third combined signal and the fourth combined signal according to signal strength of the first radio frequency signal and signal strength of the first phase shift signal, wherein signal strength of the third combined signal equals a sum of the signal strength of the first radio frequency signal and the signal strength of the first phase shift signal, and signal strength of the fourth combined signal equals a difference between the signal strength of the first radio frequency signal and the signal strength of the first phase shift signal.

3. The method for calculating an attitude angle according to claim 2, wherein the plurality of second input signals comprise a third radio frequency signal and a fourth radio frequency signal, the plurality of second output signal comprise a fifth combined signal, a sixth combined signal, a seventh combined signal, and an eighth combined signal, and the step of performing the phase operation according to the plurality of second input signals to generate the plurality of second output signals further comprises:
generating a second phase shift signal according to the fourth radio frequency signal, wherein there is a phase difference of 90° between the second phase shift signal and the fourth radio frequency signal;
generating the fifth combined signal and the sixth combined signal according to signal strength of the third radio frequency signal and signal strength of the fourth radio frequency signal, wherein signal strength of the fifth combined signal equals a sum of the signal strength of the third radio frequency signal and the signal strength of the fourth radio frequency signal, and signal strength of the sixth combined signal equals a difference between the signal strength of the third radio frequency signal and the signal strength of the fourth radio frequency signal; and
generating the seventh combined signal and the eighth combined signal according to signal strength of the third radio frequency signal and signal strength of the second phase shift signal, wherein signal strength of the seventh combined signal equals a sum of the signal strength of the third radio frequency signal and the signal strength of the second phase shift signal, and signal strength of the eighth combined signal equals a difference between the signal strength of the third radio frequency signal and the signal strength of the second phase shift signal.

4. The method for calculating an attitude angle according to claim 3, wherein the step of detecting the satellite signal by using the first antenna array to obtain the plurality of first input signals comprises:
detecting the satellite signal by using a first antenna in the first antenna array to obtain the first radio frequency signal; and
detecting the satellite signal by using a second antenna in the first antenna array to obtain the second radio frequency signal, wherein the first antenna and the second antenna are disposed in a first axial direction; and wherein:
the step of detecting the satellite signal by using the second antenna array to obtain the plurality of second input signals comprise:
detecting the satellite signal by using a third antenna in the second antenna array to obtain the third radio frequency signal; and
detecting the satellite signal by using a fourth antenna in the second antenna array to obtain the fourth radio frequency signal, wherein the third antenna and the fourth antenna are disposed in a second axial direction, and the second axial direction is perpendicular to the first axial direction.

5. The method for calculating an attitude angle according to claim 3, wherein the step of obtaining the absolute attitude angle from the satellite signal comprises obtaining the absolute attitude angle from ephemeris data carried in the plurality of first input signal and the plurality of second input signal.

6. The method for calculating an attitude angle according to claim 3, wherein the step of obtaining the absolute attitude angle from the satellite signal comprises detecting the satellite signal by using a fifth antenna to obtain a third input signal and obtaining the absolute attitude angle from ephemeris data carried in the third input signal.

7. The method for calculating an attitude angle according to claim 3, wherein the step of obtaining a relative attitude angle according to the plurality of first output signals and the plurality of second output signals further comprises:
detecting the signal strength of the first combined signal by a first positioning module to generate first signal strength;
detecting the signal strength of the second combined signal by a second positioning module to generate second signal strength;
detecting the signal strength of the third combined signal by a third positioning module to generate third signal strength;
detecting the signal strength of the fourth combined signal by a fourth positioning module to generate fourth signal strength;
detecting the signal strength of the fifth combined signal by a fifth positioning module to generate fifth signal strength;
detecting the signal strength of the sixth combined signal by a sixth positioning module to generate sixth signal strength;
detecting the signal strength of the seventh combined signal by a seventh positioning module to generate seventh signal strength;
detecting the signal strength of the eighth combined signal by an eighth positioning module to generate eighth signal strength; and
generating the relative attitude angle according to a first incident angle corresponding to the first signal strength, the second signal strength, the third signal strength, and the fourth signal strength together and a second incident angle corresponding to the fifth signal strength, the sixth signal strength, the seventh signal strength, and the eighth signal strength together.

8. The method for calculating an attitude angle according to claim 7, wherein the first antenna array is perpendicular to the second antenna array.

9. An apparatus for calculating an attitude angle, applicable to a vehicle, wherein the apparatus for calculating an attitude angle comprises:
a first antenna array, for detecting a satellite signal to obtain a plurality of first input signals;
a second antenna array, for detecting the satellite signal to obtain a plurality of second input signals;
a first signal processing unit, for performing a phase operation according to the plurality of first input signals to generate a plurality of first output signals;
a second signal processing unit, for performing the phase operation according to the plurality of second input signals to generate a plurality of second output signals; and
a processing unit, for obtaining a relative attitude angle according to the plurality of first output signal and the plurality of second output signal and generate an actual attitude angle of the vehicle according to an absolute attitude angle and the relative attitude angle, wherein the absolute attitude angle is from the satellite signal.

10. The apparatus for calculating an attitude angle according to claim 9, wherein the first antenna array comprises a first antenna and a second antenna, the plurality of first input signals comprise a first radio frequency signal and a second radio frequency signal, the first antenna is for detecting the satellite signal to obtain the first radio frequency signal, the second antenna is for detecting the satellite signal to obtain the second radio frequency signal, the plurality of first output signals comprise a first combined signal, a second combined signal, a third combined signal, and a fourth combined signal, and the first signal processing unit comprises:
a first splitter, for splitting the first radio frequency signal to generate a first split signal and a second split signal that have a same phase and same signal strength;
a first 90°-phase-shift splitter/combiner, for splitting the second radio frequency signal to generate a third split signal and a first phase shift signal that have a phase difference of 90° and same signal strength, wherein a phase difference between the first phase shift signal and the second radio frequency signal is 90°;
a second 90°-phase-shift splitter/combiner, for combining the first split signal and the third split signal to generate the first combined signal and the second combined signal, wherein signal strength of the first combined signal equals a sum of signal strength of the first radio frequency signal and signal strength of the second radio frequency signal, and signal strength of the second combined signal equals a difference between the signal strength of the first radio frequency signal and the signal strength of the second radio frequency signal; and
a third 90°-phase-shift splitter/combiner, for combining the second split signal and the first phase shift signal to generate the third combined signal and the fourth combined signal, wherein signal strength of the third combined signal equals a sum of the signal strength of the first radio frequency signal and signal strength of the first phase shift signal, and signal strength of the fourth combined signal equals a difference between the signal strength of the first radio frequency signal and the signal strength of the first phase shift signal.

11. The apparatus for calculating an attitude angle according to claim 10, wherein the second antenna array comprises a third antenna and a fourth antenna, the plurality of second input signals comprises a third radio frequency signal and a fourth radio frequency signal, the third antenna is for detecting the satellite signal to obtain the third radio frequency signal, the fourth antenna is for detecting the satellite signal to obtain the fourth radio frequency signal, the plurality of second output signals comprises a fifth combined signal, a sixth combined signal, a seventh combined signal, and an eighth combined signal, and the second signal processing unit comprises:
a second splitter, for splitting the third radio frequency signal to generate a fourth split signal and a fifth split signal that have a same phase and same signal strength;
a fourth 90°-phase-shift splitter/combiner, for splitting the fourth radio frequency signal to generate a sixth split signal and a second phase shift signal that have a phase difference of 90° and same signal strength, wherein a phase difference between the second phase shift signal and the fourth radio frequency signal is 90°;
a fifth 90°-phase-shift splitter/combiner, for combining the fourth split signal and the sixth split signal to generate the fifth combined signal and the sixth combined signal, wherein signal strength of the fifth combined signal equals a sum of signal strength of the third radio frequency signal and signal strength of the fourth radio frequency signal, and signal strength of the sixth combined signal equals a difference between the signal strength of the third radio frequency signal and the signal strength of the fourth radio frequency signal; and
a sixth 90°-phase-shift splitter/combiner, for combining the fifth split signal and the second phase shift signal to generate the seventh combined signal and the eighth combined signal, wherein signal strength of the seventh combined signal equals a sum of the signal strength of the third radio frequency signal and signal strength of the second phase shift signal, and signal strength of the eighth combined signal equals a difference between the signal strength of the third radio frequency signal and the signal strength of the second phase shift signal.

12. The apparatus for calculating an attitude angle according to claim 11, wherein the first antenna and the second antenna are disposed in a first axial direction, the third antenna and the fourth antenna are disposed in a second axial direction, and the first axial direction is perpendicular to the second axial direction.

13. The apparatus for calculating an attitude angle according to claim 11, further comprising a fifth antenna disposed between the first antenna and the second antenna and disposed between the third antenna and the fourth antenna, wherein the fifth antenna is for detecting the satellite signal to obtain the absolute attitude angle from ephemeris data of the satellite signal.

14. The apparatus for calculating an attitude angle according to claim 11, wherein the plurality of first input signals and the plurality of second input signals comprise ephemeris data, and the absolute attitude angle is from the ephemeris data of the plurality of first input signals or the ephemeris data of the plurality of second input signals.

15. The apparatus for calculating an attitude angle according to claim 11, further comprising:
a first positioning module, for detecting the signal strength of the first combined signal to generate first signal strength;
a second positioning module, for detecting the signal strength of the second combined signal to generate second signal strength;
a third positioning module, for detecting the signal strength of the third combined signal to generate third signal strength;
a fourth positioning module, for detecting the signal strength of the fourth combined signal to generate fourth signal strength;
a fifth positioning module, for detecting the signal strength of the fifth combined signal to generate fifth signal strength;
a sixth positioning module, for detecting the signal strength of the sixth combined signal to generate sixth signal strength;
a seventh positioning module, for detecting the signal strength of the seventh combined signal to generate seventh signal strength; and
an eighth positioning module, for detecting the signal strength of the eighth combined signal to generate eighth signal strength,
wherein the processing unit further generates the relative attitude angle according to a first incident angle corresponding to the first signal strength, the second signal strength, the third signal strength, and the fourth signal strength together and a second incident angle corresponding to the fifth signal strength, the sixth signal strength, the seventh signal strength, and the eighth signal strength together.

16. The apparatus for calculating an attitude angle according to claim 15, wherein the first antenna array is perpendicular to the second antenna array.
